(19) United States
(12) Patent Application Publication
(10) Pub. No.: US 2024/0412907 A1
(43) Pub. Date: Dec. 12, 2024

(54) INDUCTOR COMPONENT

(71) Applicant: Murata Manufacturing Co., Ltd., Kyoto-fu (JP)

(72) Inventor: Takeru OZAWA, Nagaokakyo-shi (JP)

(73) Assignee: Murata Manufacturing Co., Ltd., Kyoto-fu (JP)

(21) Appl. No.: 18/642,888

(22) Filed: Apr. 23, 2024

(30) Foreign Application Priority Data
Jun. 6, 2023 (JP) 2023-093333

(51) Int. Cl. H01F 5/04; H01F 27/29; H01F 27/34

(52) U.S. Cl. CPC H01F 5/04; H01F 27/292; H01F 27/346

(57) ABSTRACT

An inductor component includes an element assembly, a coil conductor inside the element assembly, and an outer electrode on an outer surface of the element assembly and electrically connected to the coil conductor. The element assembly includes a lower surface and a side surface. The outer electrode has a lower portion at the lower surface and a side portion at the side surface continuously with the lower portion. The coil conductor includes conductor patterns which form parts of an annular path on virtual inner surfaces intersecting both the lower and side surfaces and lined up at intervals. When a distance A is a shortest distance between the coil conductor and a boundary portion between the lower and side portions and a distance B is a shortest distance between the coil conductor and an end portion of the lower portion opposite the boundary portion, B/A is from 0.2 to 0.6.

### CROSS-REFERENCE TO RELATED APPLICATION

This application claims benefit of priority to Japanese Patent Application No. 2023-093333, filed Jun. 6, 2023, the entire content of which is incorporated herein by reference.

### BACKGROUND

### Technical Field

The present disclosure relates to an inductor component in which a coil conductor is provided inside an element assembly.

### Background Art

Japanese Unexamined Patent Application Publication No. 2013-98356 discloses an inductor component including an element assembly having a substantially rectangular parallelepiped shape, and an outer electrode exposed to the outside of the element assembly. A coil structure is provided inside the element assembly. The outer electrode is formed in an L shape across a bottom surface and a side surface of the element assembly, and is electrically connected with the coil structure.

### SUMMARY

In the inductor component disclosed in Japanese Unexamined Patent Application Publication No. 2013-98356, the efficiency of obtaining the L-value of the inductor component can be improved by increasing the inner diameter of the coil structure.

However, when the inner diameter of the coil structure is increased, the distance between the coil structure and the outer electrode is reduced. As a result, stray capacitance may be generated between the coil structure and the outer electrode. When stray capacitance is generated, the self resonant frequency (SRF) of the inductor component may be degraded. When the self resonant frequency is degraded, the Q-value of the inductor component may be degraded.

The present disclosure aims to provide an inductor component that can ensure high self resonant frequency and curb generation of stray capacitance.

An inductor component includes an element assembly configured of an insulator, a coil conductor provided inside the element assembly, and an outer electrode provided on an outer surface of the element assembly and electrically connected to the coil conductor. The element assembly includes a lower surface and a side surface connected to the lower surface. The outer electrode has an L shape including a lower portion provided at the lower surface and a side portion provided at the side surface continuously with the lower portion. The coil conductor includes a plurality of conductor patterns and a connection conductor. The plurality of conductor patterns are provided to form parts of an annular path on a plurality of virtual inner surfaces intersecting both the lower surface and the side surface and lined up at intervals inside the element assembly. The connection conductor electrically connects two adjacent conductor patterns among the plurality of conductor patterns. When viewed in a direction orthogonal to the virtual inner surfaces, B/A obtained by dividing a distance B by a distance A is 0.2 or greater and 0.6 or less (i.e., from 0.2 to 0.6). The distance A is a shortest distance between the coil conductor and a boundary portion between the lower portion and the side portion and the distance B is a shortest distance between the coil conductor and an end portion of the lower portion opposite the boundary portion.

According to the present disclosure, it is possible to provide an inductor component that can ensure high self resonant frequency and curb generation of stray capacitance.

### BRIEF DESCRIPTION OF THE DRAWINGS

FIG. 1 is an external perspective view of an inductor component according to an embodiment of the present disclosure;

FIG. 2 is an exploded perspective view of the inductor component illustrated in FIG. 1;

FIG. 3 is a sectional view illustrating an A-A section of FIG. 2;

FIG. 4 is a schematic transparent view of the inductor component illustrated in FIG. 1 when viewed in the direction of the central axis of the coil conductor;

FIG. 5 is a schematic transparent view of the inductor component when viewed in the direction of the central axis of the coil conductor;

FIG. 6 is an exploded plan view of the inductor component illustrated in FIG. 5;

FIG. 7 is a diagram illustrating a result of electromagnetic field simulation of changes in the self-resonant frequency with respect to a value obtained by dividing a distance B by a distance A in the inductor component illustrated in FIG. 5;

FIG. 8 is a diagram illustrating a result of electromagnetic field simulation of changes in the self resonant frequency with respect to the distance in the inductor component illustrated in FIG. 5;

FIG. 9 is a schematic transparent view of an inductor component when viewed in the direction of the central axis of a coil conductor;

FIG. 10 is an exploded plan view of the inductor component illustrated in FIG. 9;

FIG. 11 is a diagram illustrating a result of electromagnetic field simulation of changes in the Q value with respect to a distance in the inductor component illustrated in FIG. 9;

FIG. 12 is a diagram illustrating a result of electromagnetic field simulation of changes in the L value with respect to the distance in the inductor component illustrated in FIG. 9; and

FIG. 13 is a diagram illustrating a result of electromagnetic field simulation of changes in the Q value with respect to the angle of an interior angle formed by an oblique edge portion and a lower surface in the inductor component illustrated in FIG. 9.

### DETAILED DESCRIPTION

Hereinafter, an example of the present disclosure will be described with reference to the accompanying drawings. Note that the following description is essentially an example, and is not intended to limit the present disclosure, its applications, or its use range. In addition, the drawings are schematic, and the ratios or the like of dimensions do not necessarily coincide with actual values. Moreover, in the following description, terms indicating specific directions or positions are used as needed (e.g., terms including “upper,” “lower,” “right,” “left,” “front,” and “rear”). However, the terms indicating specific directions or positions are used to facilitate understanding of the present disclosure with reference to the drawings, and the meaning of the terms do not limit the technical scope of the present disclosure.

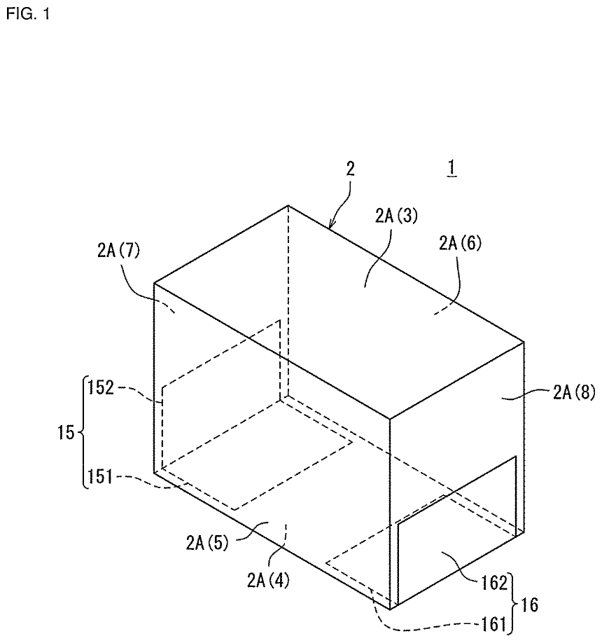

FIG. 1 is an external perspective view of an inductor component according to an embodiment of the present disclosure.

As illustrated in FIG. 1, an inductor component 1 according to the embodiment of the present disclosure includes an element assembly 2. In the present embodiment, the element assembly 2 has a rectangular parallelepiped shape. In the present embodiment, an outer surface 2A of the element assembly 2 includes an upper surface 3 facing upward, a lower surface 4 facing downward, a front side surface 5 connecting the upper surface 3 and the lower surface 4, a rear side surface 6, a left side surface 7, and a right side surface 8. The left side surface 7 and the right side surface 8 are an example of a side surface. The front side surface 5 faces the front and the rear side surface 6 faces the rear. The left side surface 7 faces the left and the right side surface 8 faces the right. Each of the front side surface 5, the rear side surface 6, the left side surface 7, and the right side surface 8 extends from the upper surface 3 in the lower direction orthogonal to the upper surface 3, and extends from the lower surface 4 in the upper direction orthogonal to the lower surface 4. In other words, on a cross section of the element assembly 2 cut in the up-down direction, the outer surface 2A of the element assembly 2 includes the lower surface 4, and the left side surface 7 and right side surface 8 extending from the lower surface 4 in the upper direction orthogonal to the lower surface 4. The up-down direction, the front-rear direction, and the left-right direction are orthogonal to each other.

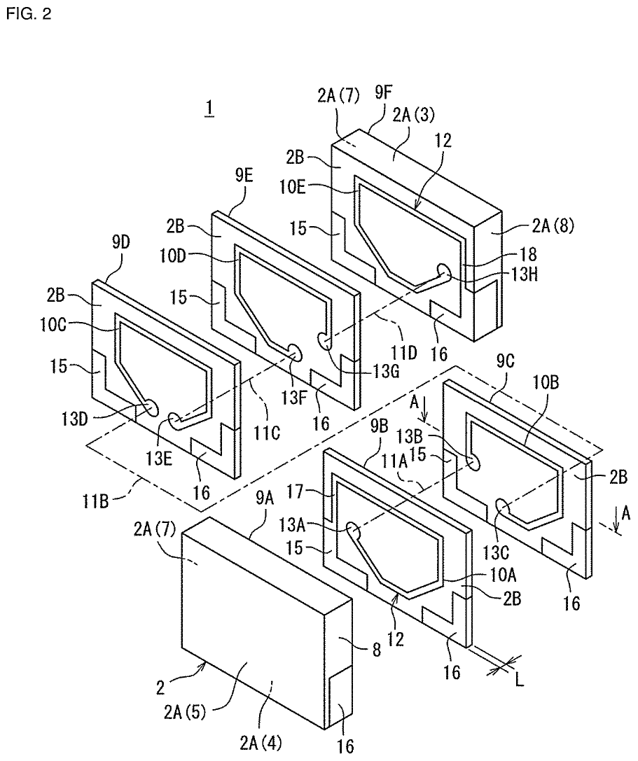

FIG. 2 is an exploded perspective view of the inductor component illustrated in FIG. 1.

As illustrated in FIG. 2, the element assembly 2 has a multilayer structure formed by laminating a plurality of insulator layers 9A to 9F. The element assembly 2 is configured of an insulator. The insulator layers 9A to 9F are laminated in a direction (front-rear direction) orthogonal to the front side surface 5 and the rear side surface 6 (see FIG. 1). Note that as can be seen from the fact that the insulator layers 9A and 9F at both ends among the insulator layers 9A to 9F are thicker than the other insulator layers 9B to 9E, the insulator layers 9A and 9F are illustrated as a multilayer body including a plurality of insulator layers.

The inductor component 1 includes a coil conductor 12 inside the element assembly 2. The coil conductor 12 includes a plurality of (five in present embodiment) conductor patterns 10A to 10E, and one or more (four in present embodiment) connection conductors 11A to 11D.

Each of the conductor patterns 10A to 10E extends along one of the interfaces between the insulator layers 9A to 9F so as to form a part of an annular path. Here, the interfaces can be paraphrased as a plurality of virtual inner surfaces 2B spreading in the up-down direction and the left-right direction and lined up at intervals in the front-rear direction inside the element assembly 2. In this case, the virtual inner surface 2B intersects the lower surface 4, the left side surface 7, and the right side surface 8. The conductor patterns 10A to 10E are provided to form a part of an annular path on the respective virtual inner surfaces 2B. Note that the annular path only needs to be annular, and may be any shape. For example, while the annular path is a hexagon in the present embodiment, the annular path is not limited to this, and may be a circle, a quadrangle, or the like.

Each of the connection conductors 11A to 11D electrically connects two conductor patterns adjacent to each other among the conductor patterns 10A to 10E. In the present embodiment, the connection conductors 11A to 11D are each a via hole conductor passing through one of the insulator layers 9B to 9E in the thickness direction. Note that the connection conductors 11A to 11D are not limited to the via hole conductors, and may be formed by printing or the like on the insulator layers 9B to 9E, for example. The connection conductors may be formed on the insulator layers 9A and 9F.

The coil conductor 12 extends in a spiral by alternately connecting the conductor patterns 10A to 10E and one or more connection conductors 11A to 11D.

The conductor patterns 10A to 10E have relatively wide pads 13A to 13H at the connection portion with the connection conductors 11A to 11D.

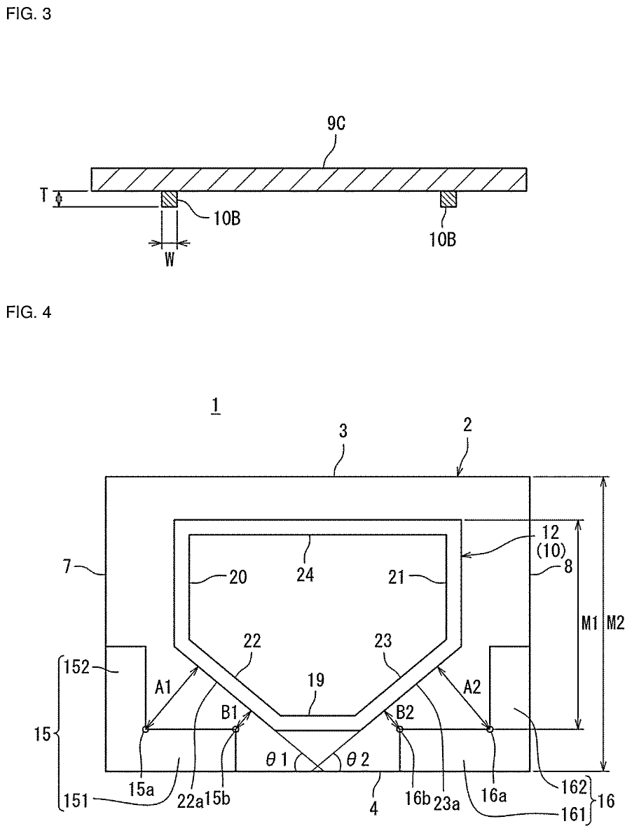

FIG. 3 is a sectional view illustrating an A-A section of FIG. 2. In the present embodiment, as illustrated in FIG. 3, T/W obtained by dividing a thickness T of the conductor pattern 10B by a width W of the conductor pattern 10B is 0.8 or greater. Here, the thickness T of the conductor pattern is a length of the conductor pattern in the axial direction of the coil conductor 12. The width W of the conductor pattern is a length of the conductor pattern in a direction orthogonal to both the direction in which the conductor pattern extends and the axial direction of the coil conductor 12. In the present embodiment, T/W is 0.8 or greater for the other conductor patterns 10A, and 10C to 10E as well. In other words, in the present embodiment, T/W is 0.8 or greater for all of the conductor patterns 10A to 10E included in the coil conductor 12.

Note that T/W may be 0.8 or greater for only some of the conductor patterns 10A to 10E included in the coil conductor 12. In other words, T/W is 0.8 or greater for at least one of the conductor patterns 10A to 10E.

As illustrated in FIG. 2, the coil conductor 12 is configured by sequentially connecting the conductor pattern 10A, the connection conductor 11A, the conductor pattern 10B, the connection conductor 11B, the conductor pattern 10C, the connection conductor 11C, the conductor pattern 10D, the connection conductor 11D, and the conductor pattern 10E.

The connection conductor 11A is connected to the conductor pattern 10A via the pad 13A, and is connected to the conductor pattern 10B via the pad 13B.

The connection conductor 11B is connected to the conductor pattern 10B via the pad 13C, and is connected to the conductor pattern 10C via the pad 13D.

The connection conductor 11C is connected to the conductor pattern 10C via the pad 13E, and is connected to the conductor pattern 10D via the pad 13F.

The connection conductor 11D is connected to the conductor pattern 10D via the pad 13G, and is connected to the conductor pattern 10E via the pad 13H.

A shortest distance L between two adjacent conductor patterns among the conductor patterns 10A to 10E is 7 μm or longer. In the present embodiment, the shortest distance L is the thickness of each of the insulator layers 9B to 9E. For example, the shortest distance L between the two adjacent conductor patterns 10A and 10B is the thickness of the insulator layer 9B. In FIG. 2 which is an exploded perspective view, the conductor pattern 10B is depicted as being separate from the insulator layer 9B. However, in practice, the conductor pattern 10B is in contact with the insulator layer 9B. The same applies to the other conductor patterns.

Note that as described earlier, the insulator layers 9A and 9F at both end portions are illustrated as a multilayer body including a plurality of insulator layers. Hence, when a conductor pattern is located, for example, inside the insulator layer 9A, the shortest distance between the conductor pattern and the conductor pattern 10A adjacent to the conductor pattern is 7 μm or longer.

Note that the numbers of the conductor patterns 10A to 10E and the connection conductors 11A to 11D connected sequentially to configure the coil conductor 12, the number of turns of the coil conductor 12, and the number of layers of the insulator layers 9A to 9F are not limited to those in the drawing, and can be any number.

As illustrated in FIG. 1, the inductor component 1 includes two outer electrodes 15 and 16 on the outer surface 2A of the element assembly 2. The outer electrode 15 has an L shape including a lower portion 151 provided in a left part of the lower surface 4 and a side portion 152 provided on the left side surface 7 continuously with the lower portion 151. The outer electrode 16 has an L shape including a lower portion 161 provided in a right part of the lower surface 4 and a side portion 162 provided on the right side surface 8 continuously with the lower portion 161. The lower portion 151 of the outer electrode 15 and the lower portion 161 of the outer electrode 16 are spaced apart from each other. The side portion 152 of the outer electrode 15 extends upward to the middle of the left side surface 7 from the lower portion 151. The side portion 162 of the outer electrode 16 extends upward to the middle of the right side surface 8 from the lower portion 161.

The lower portions 151 and 161 of the outer electrodes 15 and 16 are exposed to the outside of the element assembly 2 on the lower surface 4. The side portion 152 of the outer electrode 15 is exposed to the outside of the element assembly 2 on the left side surface 7. The side portion 162 of the outer electrode 16 is exposed to the outside of the element assembly 2 on the right side surface 8. In the present embodiment, each of the outer electrodes 15 and 16 except the exposed portions is embedded inside the element assembly 2. Note that the outer electrodes 15 and 16 may be entirely embedded inside the element assembly 2, or may be partially embedded inside the element assembly 2 such that only a part thereof protrudes from the element assembly 2.

As illustrated in FIG. 2, an extended conductor pattern 17 extending integrally from the conductor pattern 10A provided along the interface between the insulator layers 9A and 9B is connected to the outer electrode 15. An extended conductor pattern 18 extending integrally from the conductor pattern 10E provided along the interface between the insulator layers 9E and 9F is connected to the outer electrode 16. Thus, one end portion of the coil conductor 12 is electrically connected to the outer electrode 15 with the extended conductor pattern 17 interposed therebetween, and the other end portion of the coil conductor 12 is electrically connected to the outer electrode 16 with the extended conductor pattern 18 interposed therebetween. Note that the coil conductor 12 may be electrically connected to the outer electrodes 15 and 16 at parts other than the one end portion and the other end portion.

When the inductor component 1 is mounted on a circuit board (not illustrated), the lower surface 4 serves as a mounting surface facing the circuit board. Accordingly, in the present embodiment, the direction of the magnetic flux given by the coil conductor 12 is parallel to the mounting surface.

The inductor component 1 is manufactured as follows, for example.

Basically, the following four techniques are applied. A first technique is a technique of forming a plurality of insulator paste layers to be the insulator layers 9A to 9F by applying, for example, a photosensitive insulator paste mainly including borosilicate glass on a carrier film by printing. A second technique is a technique of forming a wiring conductor such as the conductor patterns 10A to 10E on a specific insulator paste layer by using, for example, a photosensitive conductive paste including silver (Ag) as a main metal component. A third technique is a technique of forming a hole or groove for placing the connection conductors 11A to 11D or the outer electrodes 15 and 16 on a specific insulator paste layer. A fourth technique is a technique of laminating the insulator paste layers, cutting the laminate to have a predetermined dimension, and subjecting the laminate to firing.

1. In order to produce the insulator layer 9A illustrated in FIG. 2, printing with the aforementioned photosensitive insulator paste is repeated on a carrier film to form the photosensitive insulator paste layer having a plurality of layers.

Here, the photosensitive insulator paste layer which is a part of the insulator layer 9A and which is to be the outermost insulator layer is fully exposed to ultraviolet radiation. Note that the obtained insulator layer to be the outermost layer may be colored differently from other insulator layers to facilitate detection of overturning or the like when the inductor component 1 is mounted.

In addition, the photosensitive insulator paste layer which is a remaining part of the insulator layer 9A and which is to be the insulator layer with the outer electrodes 15 and 16 is subjected to a photolithography technique to form grooves for placing the outer electrodes 15 and 16. The grooves are filled with the photosensitive conductive paste.

2. In order to produce the insulator layers 9B to 9E illustrated in FIG. 2, the photosensitive insulator paste layers to be the insulator layers 9B to 9E are formed on the carrier film. In addition, the photolithography technique is applied to the photosensitive insulator paste layers to form holes for placing the connection conductors 11A to 11D and grooves for placing the outer electrodes 15 and 16.

Next, the photosensitive conductive paste layer is applied by printing on the photosensitive insulator paste layers. At this time, the aforementioned holes for placing the connection conductors 11A to 11D and the grooves for placing the outer electrodes 15 and 16 are filled with the photosensitive conductive paste. Subsequently, the photolithography technique is applied to the photosensitive conductive paste layers and patterning is performed to obtain the conductor patterns 10A to 10D having the pads 13A to 13G.

3. In order to produce the insulator layer 9F illustrated in FIG. 2, printing with the aforementioned photosensitive insulator paste is repeated on the carrier film. As a result, the photosensitive insulator paste layer having a plurality of layers is formed.

Here, the photosensitive insulator paste layer which is a part of the insulator layer 9F and which is to be the outermost insulator layer is fully exposed to ultraviolet radiation as in the case of the aforementioned insulator layer 9A. At this time, coloring different from other insulator layers may be performed.

In addition, the photosensitive insulator paste layer which is a remaining part of the insulator layer 9F and which is to be the insulator layer with only the outer electrodes 15 and 16 is subjected to the photolithography technique to form grooves for placing the outer electrodes 15 and 16. The grooves are filled with the photosensitive conductive paste.

In addition, the photosensitive insulator paste layer on which the outer electrodes 15 and 16 and the conductor pattern 10E having the pad 13H are to be formed is subjected to the photolithography technique to first form the grooves for placing the outer electrodes 15 and 16. Subsequently, the photosensitive conductive paste layer is applied by printing on the photosensitive insulator paste layer. At this time, the aforementioned grooves for placing the outer electrodes 15 and 16 are filled with the photosensitive conductive paste. Subsequently, the photolithography technique is applied to the photosensitive conductive paste layer and patterning is performed to obtain the conductor pattern 10E having the pad 13H.

4. Next, the aforementioned photosensitive insulator paste layers are sequentially laminated, so that the insulator layers 9A to 9F are laminated in the order illustrated in FIG. 2. As a result, a mother multilayer body is obtained.

5. The mother multilayer body is, for example, cut with a dicing machine or cut by push-cutting to obtain a plurality of unfired component main bodies. The outer electrodes 15 and 16 are exposed on a cut surface obtained by the cutting.

6. The unfired component main bodies are subjected to firing under predetermined conditions, whereby the element assembly 2 is obtained. This firing causes the element assembly 2 to contract. For example, barrel polishing is performed on the element assembly 2.

7. A plating film is formed, if necessary, on a part of the outer electrodes 15 and 16 that is exposed from the element assembly 2. The plating film is configured of, for example, a Ni plating layer or a Cu plating layer and an Sn plating layer formed thereon.

8. Thus, the inductor component 1 is completed.

Hereinafter, the configuration of the inductor component 1 will be described by mainly referring to FIG. 4. FIG. 4 is a schematic transparent view of the inductor component illustrated in FIG. 1 when viewed in the direction of the central axis of the coil conductor. In other words, FIG. 4 is a schematic transparent view of the inductor component 1 when viewed in a direction orthogonal to the virtual inner surfaces 2B. In FIG. 4, only the outer electrodes 15 and 16, and the conductor patterns 10A to 10E of the coil conductor 12 are shown, and the connection conductors 11A to 11D, the extended conductor patterns 17 and 18, and the pads 13A to 13H are omitted. Note that in FIG. 4, the conductor patterns 10A to 10E overlapping each other are collectively referred to by the reference numeral “10”.

As illustrated in FIG. 4, the conductor pattern 10 included in the inductor component 1 has a hexagonal shape having a lower edge portion 19, two side edge portions 20 and 21, two oblique edge portions 22 and 23, and an upper edge portion 24.

The lower edge portion 19 extends in a straight line parallel to the lower surface 4.

The lower edge portion 19 is located higher than the lower portion 151 of the outer electrode 15 and the lower portion 161 of the outer electrode 16. Here, the lower edge portion 19 is located in the lowest part of the coil conductor 12. In other words, the coil conductor 12 is located on the opposite side of the lower surface 4 with respect to the part of the lower surface 4 where the lower portions 151 and 161 are embedded in the up-down direction, which is perpendicular to the lower surface 4.

The two side edge portions 20 and 21 extend in a straight line parallel to the left side surface 7 and the right side surface 8, respectively.

The oblique edge portion 22 connects an end portion of the lower edge portion 19 close to the left side surface 7 and a lower end portion of the side edge portion 20 in an oblique direction with respect to the lower surface 4. To be specific, the oblique edge portion 22 extends upward while extending toward the left side. In other words, in the left-right direction parallel to the lower surface 4, the oblique edge portion 22 extends so as to separate from the lower surface 4 in the up-down direction perpendicular to the lower surface 4 as the oblique edge portion 22 approaches the left side surface 7.

The oblique edge portion 23 connects an end portion of the lower edge portion 19 close to the right side surface 8 and a lower end portion of the side edge portion 21 in an oblique direction with respect to the lower surface 4. To be specific, the oblique edge portion 23 extends upward while extending toward the right side. In other words, in the left-right direction, the oblique edge portion 23 extends so as to separate from the lower surface 4 in the up-down direction as the oblique edge portion 23 approaches the right side surface 8.

In the embodiment illustrated in the drawing, as can be seen from the fact that the oblique edge portions 22 and 23 in FIG. 4 have linearly extending shapes, the oblique edge portions 22 and 23 are formed so as to join both the end portions in the left-right direction of the lower edge portion 19 and the respective lower end portions of the side edge portions 20 and 21 by the shortest distance.

The upper edge portion 24 extends in a straight line parallel to the upper surface 3.

Note that the shapes of the lower edge portion 19, the two side edge portions 20 and 21, the two oblique edge portions 22 and 23, and the upper edge portion 24 are not limited to those described above, and may be any shape.

For example, the lower edge portion 19 and the upper edge portion 24 do not have to extend parallel to the lower surface 4, and do not have to be straight. For example, the lower edge portion 19 and the upper edge portion 24 may extend obliquely with respect to the lower surface 4, and may have a curved shape such as an arc or a wavy line. The upper edge portion 24 is located relatively far from the outer electrodes 15 and 16. Hence, the upper edge portion 24 does not affect the aforementioned stray capacitance problem as much as the lower edge portion 19.

The present embodiment describes a configuration in which all of the conductor patterns 10A to 10E included in the inductor component 1 include the oblique edge portions 22 and 23. However, another configuration is conceivable in which some (e.g., the conductor patterns 10A and 10B) of the conductor patterns 10A to 10E include the oblique edge portions 22 and 23, but the rest (e.g., the conductor patterns 10C TO 10E) do not have to include the oblique edge portions 22 and 23. In other words it is only necessary that at least one of the conductor patterns 10A to 10E includes the oblique edge portions 22 and 23.

In the present embodiment, both a length A1 of a perpendicular extending down to an outer peripheral edge 22a of the oblique edge portion 22 from an L-shaped inner corner portion 15a of the outer electrode 15, and a length A2 of a perpendicular extending down to an outer peripheral edge 23a of the oblique edge portion 23 from an L-shaped inner corner portion 16a of the outer electrode 16 are 57 μm or longer and 78 μm or shorter (i.e., from 57 μm to 78 μm). The inner corner portion 15a is a boundary portion between the lower portion 151 and the side portion 152 of the outer electrode 15. The inner corner portion 16a is a boundary portion between the lower portion 161 and the side portion 162 of the outer electrode 16. The length A1 is the shortest distance between the inner corner portion 15a and the coil conductor 12. The length A2 is the shortest distance between the inner corner portion 16a and the coil conductor 12. The lengths A1 and A2 are an example of a distance A.

In the present embodiment, both a length B1 of a perpendicular extending down to the outer peripheral edge 22a of the oblique edge portion 22 from an end portion 15b of the lower portion 151 of the outer electrode 15 opposite the inner corner portion 15a, and a length B2 of a perpendicular extending down to the outer peripheral edge 23a of the oblique edge portion 23 from an end portion 16b of the lower portion 161 of the outer electrode 16 opposite the inner corner portion 16a are 14 μm or longer and 45 μm or shorter (i.e., from 14 μm to 45 μm). The length B1 is the shortest distance between the end portion 15b and the coil conductor 12. The length B2 is the shortest distance between the end portion 16b and the coil conductor 12. The lengths B1 and B2 are an example of a distance B.

In the inductor component 1, a value obtained by dividing the distance B by the distance A, that is, B/A, is 0.2 or greater and 0.6 or smaller (i.e., from 0.2 to 0.6).

In the present embodiment, as can be seen from the fact that FIG. 4 has a symmetrical geometric form, the length A1 is equal to the length A2, and the length B1 is equal to the length B2. However, the length A1 may be different from the length A2, and the length B1 may be different from the length B2.

Note that in a case where the inner corner portions 15a and 16a of the outer electrodes 15 and 16 as starting points of the lengths A1 and A2 are rounded, the starting points are located on the round portions of the inner corner portions. In a case where the end portions 15b and 16b of the outer electrodes 15 and 16 as starting points of the lengths B1 and B2 are rounded, the starting points are located on the round portions of the end portions.

Moreover, the conductor patterns 10A to 10E included in the inductor component may be formed so as to extend in a spiral shape beyond one turn on one interface between the insulator layers. In this case, the outer peripheral edges 22a and 23a of the oblique edge portions 22 and 23 as end points of the lengths A1 and A2 and the lengths B1 and B2 are given by the outer peripheral edge of the circulatory conductor layer located in the outermost portion.

In the present embodiment, an interior angle θ1 formed by the oblique edge portion 22 and the lower surface 4 and an interior angle θ2 formed by the oblique edge portion 23 and the lower surface 4 are 15 degrees or greater and 40 degrees or smaller (i.e., from 15 degrees to 40 degrees). While the interior angle θ1 is equal to the interior angle θ1 in the present embodiment, the interior angle θ1 may be different from the interior angle θ2.

In the present embodiment, a dimension M1 of the annular path in the up-down direction perpendicular to the lower surface 4 is 0.6 times or more and 0.85 times or less (i.e., from 0.6 times to 0.85 times) of a dimension M2 of the element assembly 2 in the up-down direction. Here, the dimension M1 of the annular path in the up-down direction refers to the maximum dimension of the annular path in the up-down direction, and the dimension M2 of the element assembly 2 in the up-down direction refers to the maximum dimension of the element assembly 2 in the up-down direction.

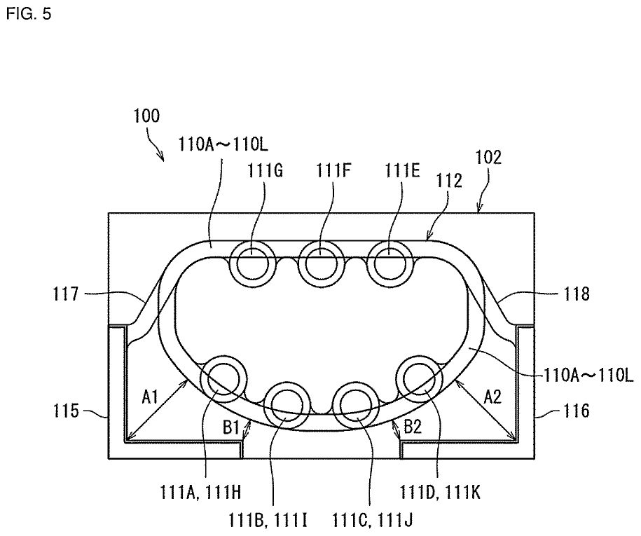

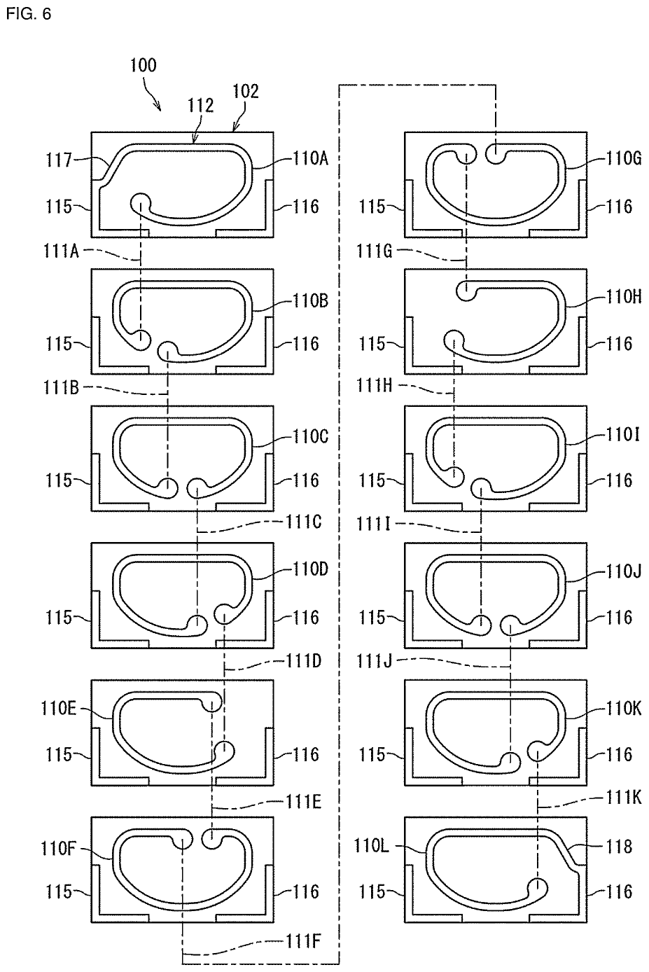

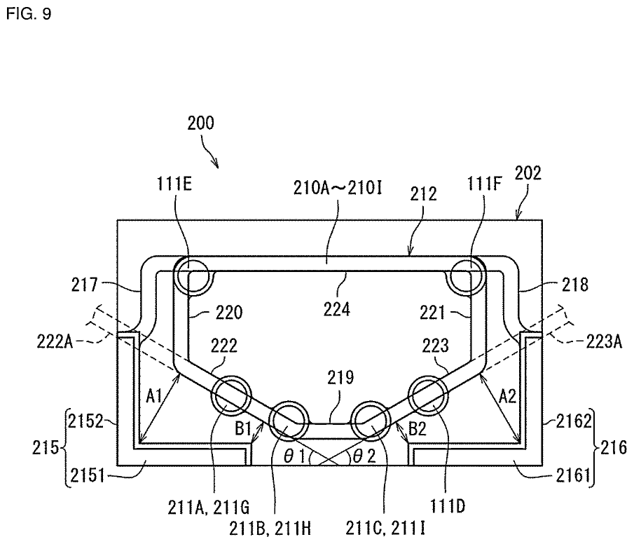

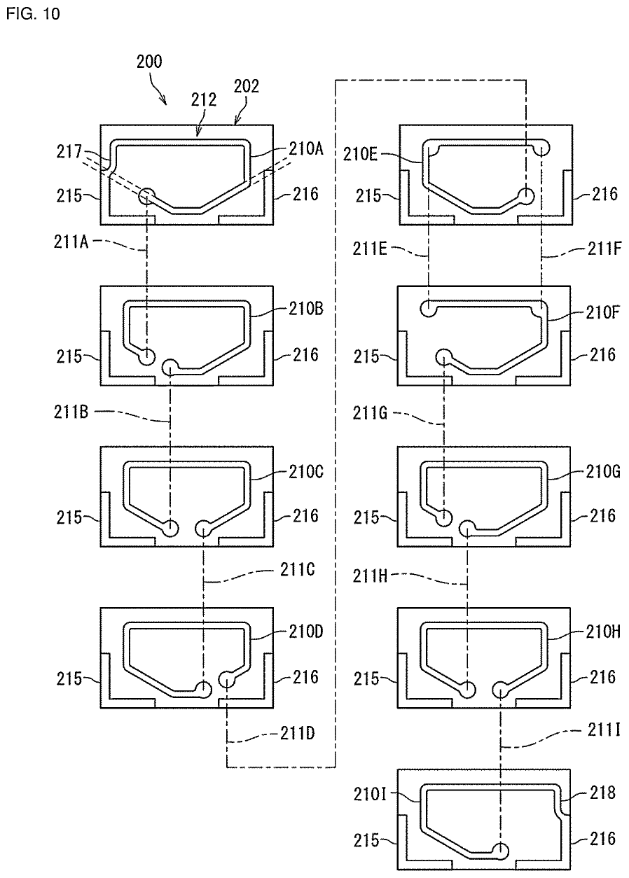

The following simulation was performed on an inductor component 100 (see FIGS. 5 and 6) and an inductor component 200 (see FIGS. 9 and 10). Note that in the inductor components 100 and 200, parts configured similarly to those in the inductor component 1 are assigned the same reference numerals as in the inductor component 1 and description thereof is omitted.

First, the configuration of the inductor component 100 is described.

FIG. 5 is a schematic transparent view of the inductor component when viewed in the direction of the central axis of the coil conductor. FIG. 6 is an exploded plan view of the inductor component illustrated in FIG. 5.

The inductor component 100 is different from the inductor component 1 illustrated in FIGS. 1 to 4 in the number of insulator layers, the number of turns of a coil conductor 112, and the shape of conductor patterns 110A to 110L of the coil conductor 112. In addition, although detailed description is omitted, due to the above differences, the inductor component 100 is different from the inductor component 1 in the number and location of pads (not illustrated) and the number and location of connection conductors 111A to 111K as well.

As illustrated in FIG. 6, the inductor component 100 has an element assembly 102 having 12 layers provided with the coil conductor 112 with a 10.5 turn structure. The coil conductor 112 includes the conductor patterns 110A to 110L and the connection conductors 111A to 111K. Each of the connection conductors 111A to 111K electrically connects two conductor patterns adjacent to each other among the conductor patterns 110A to 110L. As a result, the coil conductor 112 extends in a spiral by alternately connecting the conductor patterns 110A to 110L and the connection conductors 111A to 111K.

The conductor pattern 110A is electrically connected to an outer electrode 115 with a conductor pattern 117 interposed therebetween. The conductor pattern 110L is electrically connected to the outer electrode 116 with the conductor pattern 118 interposed therebetween.

Each of the conductor patterns 10A to 10E included in the inductor component 1 described earlier forms a hexagon having six bent portions. On the other hand, each of the conductor patterns 110A to 110L included in the inductor component 100 has curved portions instead of the six bent portions. In other words, each of the conductor patterns 110A to 110L is smoothly curved at respective boundary portions with two side edge portions, two oblique edge portions, and an upper edge portion. In this regard, the shape of each of the conductor patterns 110A to 110L is different from the shape of each of the conductor patterns 10A to 10E.

Next, the simulation performed on the inductor component 100 will be described.

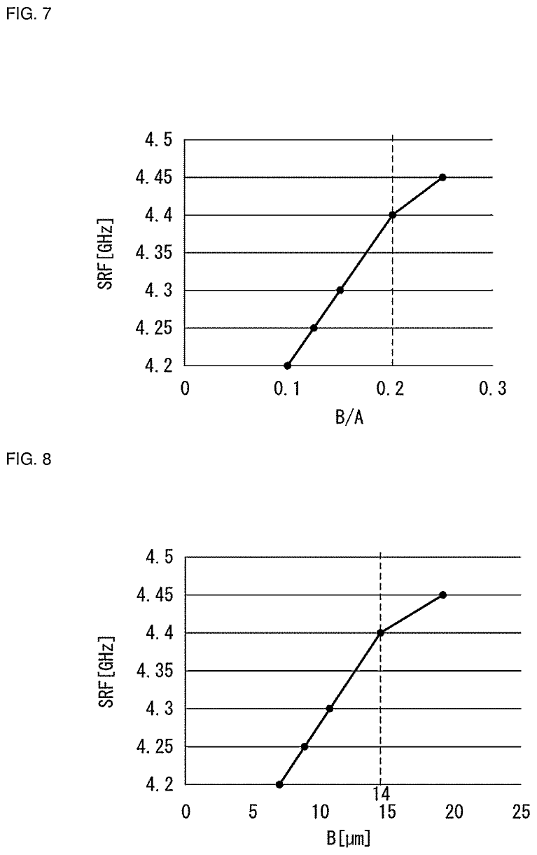

FIG. 7 is a diagram illustrating a result of electromagnetic field simulation of changes in the self resonant frequency with respect to the value obtained by dividing a distance B by a distance A in the inductor component illustrated in FIG. 5.

Regarding the inductor component 100, a simulation was performed using an electromagnetic field simulator to observe how the self resonant frequency changes when B/A is varied within the range of approximately 0.1 to approximately 0.25 by changing at least one of the distance A and distance B. As illustrated in FIG. 7, the self resonant frequency decreases as B/A decreases.

As illustrated in FIG. 7, the rate of decrease in self resonant frequency with respect to the decrease in B/A when B/A is less than 0.2 is larger than the rate of decrease in self resonant frequency with respect to the decrease in B/A when B/A is 0.2 or greater. In the inductor component 1 according to the present embodiment, B/A is 0.2 or greater, and therefore the decrease in self resonant frequency can be curbed as compared to a configuration in which B/A is less than 0.2. As a result, high self resonant frequency can be ensured.

FIG. 8 is a diagram illustrating a result of electromagnetic field simulation of changes in the self resonant frequency with respect to the distance B in the inductor component illustrated in FIG. 5.

Regarding the inductor component 100, a simulation was performed using an electromagnetic field simulator to observe how the self resonant frequency changes when the distance B is varied within the range of approximately 7 μm to approximately 20 μm. As illustrated in FIG. 8, the self resonant frequency decreases as the distance B decreases.

The rate of decrease in self resonant frequency with respect to the decrease in the distance B when the distance B is shorter than 14 μm is larger than the rate of decrease in self resonant frequency with respect to the decrease in the distance B when the distance B is 14 μm or longer. In the inductor component 1 according to the present embodiment, the distance B is 14 μm or longer, and therefore the decrease in self resonant frequency can be curbed as compared to a configuration in which the distance B is shorter than 14 μm.

Note that results similar to those of FIGS. 7 and 8 are obtained when a simulation is performed on an inductor component (e.g., inductor component 200 described later) having a shape different from the inductor component 100.

Next, the configuration of the inductor component 200 will be described.

FIG. 9 is a schematic transparent view of the inductor component when viewed in the direction of the central axis of a coil conductor. FIG. 10 is an exploded plan view of the inductor component illustrated in FIG. 9.

The inductor component 200 is different from the inductor component 1 illustrated in FIGS. 1 to 4 in the number of insulator layers, the number of turns of a coil conductor 212, and the shape of conductor patterns 210A to 210I of the coil conductor 212. In addition, although detailed description is omitted, due to the above differences, the inductor component 200 is different from the inductor component 1 in the number and location of pads (not illustrated) and the number and location of connection conductors 211A to 211I as well.

As illustrated in FIG. 10, the inductor component 200 has an element assembly 202 having nine layers provided with the coil conductor 212 with a 6.5 turn structure. The coil conductor 212 includes the conductor patterns 210A to 210I and the connection conductors 211A to 211I. Each of the connection conductors 211A to 211I electrically connects two conductor patterns adjacent to each other among the conductor patterns 210A to 210I. As a result, the coil conductor 212 extends in a spiral by alternately connecting the conductor patterns 210A to 210I and the connection conductors 211A to 211I.

The conductor pattern 210A is electrically connected to an outer electrode 215 with a conductor pattern 217 interposed therebetween. The conductor pattern 210I is electrically connected to an outer electrode 216 with a conductor pattern 218 interposed therebetween. Note that as with the outer electrodes 15 and 16 of the inductor component 1, the outer electrode 215 has an L shape formed of a lower portion 2151 and a side portion 2152, and the outer electrode 216 has an L shape formed of a lower portion 2161 and a side portion 2162 (see FIG. 9).

As illustrated in FIG. 9, as with each of the conductor patterns 10A to 10E included in the inductor component 1 described earlier, each of the conductor patterns 210A to 210I included in the inductor component 200 according to a modification has a lower edge portion 219, two side edge portions 220 and 221, two oblique edge portions 222 and 223, and an upper edge portion 224.

In the inductor component 200, extended portions 222A and 223A obtained by virtually extending the oblique edge portions 222 and 223 intersect the side portions 2152 and 2162 of the outer electrodes 215 and 216. In FIG. 9, the extended portions 222A and 223A are indicated by a broken line.

Next, the simulation performed on the inductor component 200 will be described.

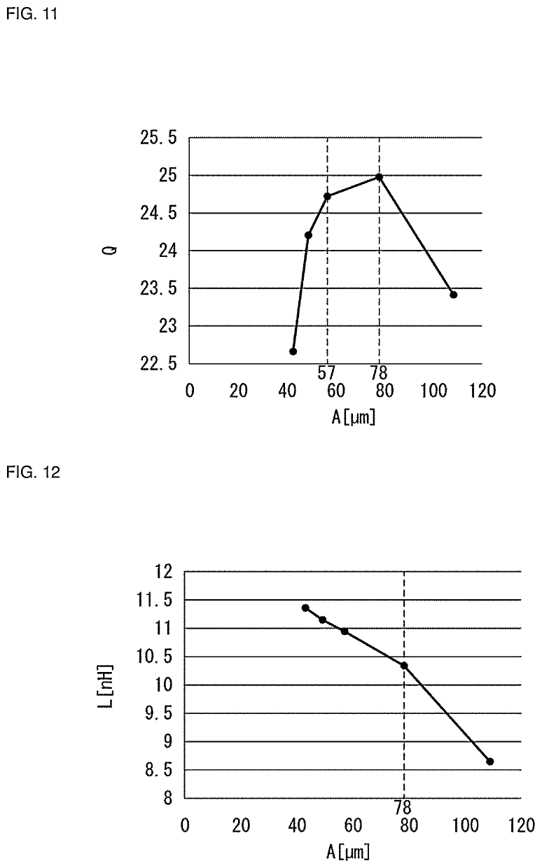

FIG. 11 is a diagram illustrating a result of electromagnetic field simulation of changes in the Q value with respect to a distance A in the inductor component illustrated in FIG. 9.

Regarding the inductor component 200, a simulation was performed using an electromagnetic field simulator to observe how the Q value changes when the distance A is varied within the range of approximately 40 μm to approximately 110 μm. As illustrated in FIG. 11, the Q value decreases as the distance A increases when the distance A is longer than 78 μm, and the Q value decreases as the distance A decreases when the distance A is shorter than 78 μm.

When the distance A is shorter than 57 μm, the Q value of the inductor component declines sharply with the decrease in the distance A. When the distance A is longer than 78 μm, the Q value of the inductor component declines sharply with the increase in the distance A. On the other hand, when the distance A is 57 μm or longer and 78 μm or shorter (i.e., from 57 μm to 78 μm) as in the case of the inductor component 1 according to the present embodiment, the Q value of the inductor component maintains a higher value than when the distance A is shorter than 57 μm or when the distance A is longer than 78 μm. In other words, with the inductor component 1 according to the present embodiment, a high Q value can be ensured.

FIG. 12 is a diagram illustrating a result of electromagnetic field simulation of changes in the L value with respect to the distance A in the inductor component illustrated in FIG. 9.

Regarding the inductor component 200, a simulation was performed using an electromagnetic field simulator to observe how the L value changes when the distance A is varied within the range of approximately 40 μm to approximately 110 μm. As illustrated in FIG. 12, the L value decreases as the distance A increases.

The rate of decrease in the L value with respect to the increase in the distance A when the distance A is longer than 78 μm is larger than the rate of decrease in the L value with respect to the increase in the distance A when the distance A is 78 μm or shorter. In the inductor component 1 according to the present embodiment, the distance A is 78 μm or shorter, and therefore the decrease in the L value can be curbed as compared to a configuration in which the distance A is longer than 78 μm. As a result, a high L value can be ensured.

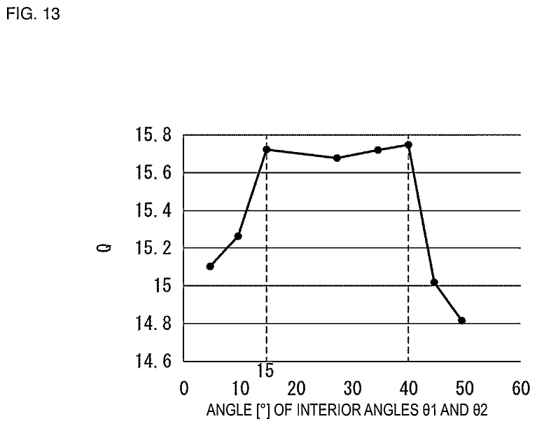

FIG. 13 is a diagram illustrating a result of electromagnetic field simulation of changes in the Q value with respect to the angle of interior angles θ1 and 02 formed by an oblique edge portion and a lower surface in the inductor component illustrated in FIG. 9.

Regarding the inductor component 200, a simulation was performed using an electromagnetic field simulator to observe how the Q value changes when the angle of the interior angles θ1 and 02 is varied within the range of approximately 15 degrees to approximately 40 degrees. As illustrated in FIG. 13, the Q value decreases as the angle of the interior angles θ1 and 02 decreases when the angle of the interior angles θ1 and 02 is smaller than 15 degrees, and the Q value decreases as the angle of the interior angles θ1 and 02 increases when the angle of the interior angles θ1 and 02 is larger than 40 degrees. On the other hand, when the angle of the interior angles θ1 and 02 is 15 degrees to 40 degrees, the angle of the interior angles θ1 and 02 maintains a larger Q value than when the angle of the interior angles θ1 and 02 is smaller than 15 degrees or when the angle of the interior angles θ1 and 02 is larger than 40 degrees.

When the angle of the interior angles θ1 and 02 formed of the oblique edge portions and the lower surface is smaller than 15 degrees, the Q value of the inductor component declines sharply with the decrease in the angle of the interior angles θ1 and 02. When the angle of the interior angles θ1 and 02 is larger than 40 degrees, the Q value of the inductor component declines sharply with the increase in the angle of the interior angles θ1 and 02. On the other hand, when the angle of the interior angles θ1 and 02 is 15 degrees or larger and 40 degrees or smaller as in the case of the inductor component 1 according to the present embodiment, the Q value of the inductor component 1 maintains a higher value than when the angle of the interior angles θ1 and 02 is smaller than 15 degrees or when the angle of the interior angles θ1 and 02 is larger than 40 degrees. In other words, with the inductor component 1 according to the present embodiment, a high Q value can be ensured.

Note that results similar to those of FIGS. 11 to 13 are obtained when a simulation is performed on an inductor component (e.g., inductor component 100 described earlier) having a shape different from the inductor component 200.

Hereinafter, other effects of the present embodiment will be described.

As B/A increases, the positional relationship between the lower portions 151 and 161 of the outer electrodes 15 and 16 and a part (oblique edge portions 22 and 23) of the conductor pattern near the lower surface comes close to parallel. As a result, stray capacitance tends to be generated between the lower portion of the outer electrode and the part of the conductor pattern near the lower surface. Since B/A of the inductor component 1 according to the present embodiment is 0.6 or less, the generation of stray capacitance can be curbed as compared to a configuration in which B/A is greater than 0.6.

As the distance B increases, the inner diameter of the coil conductor decreases and the L value decreases. In the inductor component 1 according to the present embodiment, the distance B is 45 μm or shorter. Hence, it is possible to keep the inner diameter of the coil conductor from becoming excessively small.

According to the present embodiment, the oblique edge portions 22 and 23 extend obliquely with respect to the lower surface 4, the left side surface 7, and the right side surface 8. On the other hand, the outer electrodes 15 and 16 are provided along the lower surface 4, the left side surface 7, and the right side surface 8. Hence, the distance between the conductor patterns 10A to 10E (oblique edge portions 22 and 23) and the outer electrodes 15 and 16 can be made longer than the configuration in the related art in which the conductor patterns 10A to 10E do not include the oblique edge portions 22 and 23 and are parallel to the lower surface 4. As a result, generation of stray capacitance between the oblique edge portions 22 and 23 and the outer electrodes 15 and 16 can be curbed.

In a case where the distance between the conductor patterns 10A to 10E and the outer electrodes 15 and 16 is the same for the present embodiment and the configuration in the related art, the present embodiment having the oblique edge portions 22 and 23 can make the inner diameter of the coil conductor 12 larger than the configuration in the related art not having the oblique edge portions 22 and 23.

The configuration in which the extended portions 222A and 223A intersect the side portions 152 and 162 can make the inner diameter of the coil conductor 12 larger than a configuration in which the extended portions 222A and 223A do not intersect the side portions 152 and 162.

According to the present embodiment, the dimension M1 of the annular path in the up-down direction perpendicular to the lower surface 4 is 0.6 times or more of the dimension M2 of the element assembly 2 in the up-down direction, and therefore the inner diameter of the coil conductor 12 can be made larger than a configuration in which the dimension M1 is less than 0.6 times of the dimension M2.

When the dimension M1 of the annular path in the up-down direction perpendicular to the lower surface 4 comes close to the dimension M2 of the element assembly 2 in the up-down direction (i.e., comes close to a factor of one), the conductor patterns 10A to 10E are more likely to be exposed to the outside of the element assembly 2 due to production variations. According to the present embodiment, the dimension M1 of the annular path in the up-down direction is 0.85 times or less of the dimension M2 of the element assembly 2 in the up-down direction. Hence, it is possible to keep the conductor patterns 10A to 10E from easily being exposed to the outside of the element assembly 2 as compared to a configuration in which the dimension M1 is more than 0.85 times of the dimension M2.

In the case of a configuration (hereinafter referred to as overlapping configuration) in which a part of the coil conductor 12 overlaps an embedded part of the lower portions 151 and 161 in the up-down direction, the coil conductor 12 comes close to the lower surface 4, and therefore the distance between the coil conductor 12 and the lower surface 4 becomes short. As a result, the coil conductor 12 is more likely to be exposed to the lower surface 4 of the element assembly 2 due to production variations. According to the present embodiment, the coil conductor 12 is located on the opposite side of the lower surface 4 with respect to the part of the lower surface 4 where the lower portions 151 and 161 are embedded in the up-down direction. In the case of the present embodiment, the distance between the coil conductor 12 and the lower surface 4 becomes longer than in the overlapping configuration. Hence, according to the present embodiment, it is possible to keep the coil conductor 12 from being easily exposed to the lower surface 4 of the element assembly 2 as compared to the overlapping configuration.

According to the present embodiment, it is possible to reduce the electrical resistance of the coil conductor 12 at a high frequency as compared to a configuration in which T/W is less than 0.8.

According to the present embodiment, it is possible to curb generation of stray capacitance between two adjacent conductor patterns as compared to a configuration in which the distance between the two conductor patterns is shorter than 7 μm. As a result, high self resonant frequency can be ensured.

While the present embodiment describes an example in which the inductor component 1 includes two outer electrodes 15 and 16, the number of outer electrodes 15 and 16 included in the inductor component 1 is not limited to two.

While the present embodiment describes an example in which each of the conductor patterns 10A to 10E has a hexagonal shape having six bent portions, the configuration of each of the conductor patterns 10A to 10E is not limited to a hexagon. For example, each of the conductor patterns 10A to 10E may have a curved portion instead of the bent portion as in each of the conductor patterns 110A to 110L included in the aforementioned inductor component 100. Moreover, for example, the number of oblique edge portions of each of the conductor patterns 10A to 10E is not limited to two.

While the present embodiment describes an example in which the element assembly 2 has a rectangular parallelepiped shape, the element assembly 2 is not limited to the rectangular parallelepiped shape. For example, the element assembly 2 may be cylindrical and include an upper surface, a lower surface, and one side surface connecting the upper surface and the lower surface. In this case also, as in the case of the present embodiment, on a cross section of the element assembly 2 cut in the up-down direction, the outer surface of the element assembly 2 can include a lower surface, and a left side surface and a right side surface extending from the lower surface in the upper direction orthogonal to the lower surface. Moreover, an outer electrode may be provided in each of the left side surface and the right side surface. In other words, even when the element assembly 2 is cylindrical, the inductor component 1 can include two outer electrodes on one side surface.

The inductor component described above can also be expressed as follows.

(1) An inductor component of an aspect of the present disclosure includes an element assembly configured of an insulator; a coil conductor provided inside the element assembly; and an outer electrode provided on an outer surface of the element assembly and electrically connected to the coil conductor. The element assembly includes a lower surface and a side surface connected to the lower surface. The outer electrode has an L shape including a lower portion provided at the lower surface and a side portion provided at the side surface continuously with the lower portion. The coil conductor includes a plurality of conductor patterns and a connection conductor, the plurality of conductor patterns being provided to form parts of an annular path on a plurality of virtual inner surfaces intersecting both the lower surface and the side surface and lined up at intervals inside the element assembly, the connection conductor electrically connecting two adjacent conductor patterns among the plurality of conductor patterns. Also, when viewed in a direction orthogonal to the virtual inner surfaces, B/A obtained by dividing a distance B by a distance A is 0.2 or greater and 0.6 or less (i.e., from 0.2 to 0.6), where the distance A is a shortest distance between the coil conductor and a boundary portion between the lower portion and the side portion and the distance B is a shortest distance between the coil conductor and an end portion of the lower portion opposite the boundary portion.

(2) In the inductor component of (1), the distance A may be 57 μm or longer and 78 μm or shorter (i.e., from 57 μm to 78 μm).

(3) In the inductor component of (1) or (2), the distance B may be 14 μm or longer and 45 μm or shorter (i.e., from 14 μm to 45 μm).

(4) In the inductor component of any one of (1) to (3), at least one of the plurality of conductor patterns may include an oblique edge portion extending toward the side surface in a direction parallel to the lower surface to separate from the lower surface in a direction perpendicular to the lower surface.

(5) In the inductor component of (4), an interior angle formed by the oblique edge portion and the lower surface when viewed in the direction orthogonal to the virtual inner surfaces may be 15 degrees or larger and 40 degrees or smaller.

(6) In the inductor component of (4) or (5), an extended portion obtained by virtually extending the oblique edge portion may intersect the side portion.

(7) In the inductor component of any one of (1) to (6), a dimension of the annular path in a direction perpendicular to the lower surface may be 0.6 times or more and 0.85 times or less (i.e., from 0.6 times to 0.85 times) of a dimension of the element assembly in the direction perpendicular to the lower surface.

(8) In the inductor component of any one of (1) to (7), at least a part of the lower portion may be embedded in the element assembly, and the coil conductor may be located on an opposite side of the lower surface with respect to the part of the lower portion embedded in a direction perpendicular to the lower surface.

(9) In the inductor component of any one of (1) to (8), in at least one of the plurality of conductor patterns, T/W obtained by dividing a thickness T of the at least one of the conductor patterns by a width W of the at least one of the conductor patterns may be 0.8 or greater.

(10) In the inductor component of any one of (1) to (9), a shortest distance between the two adjacent conductor patterns among the plurality of conductor patterns may be 7 μm or longer.

Note that effects of the embodiments can be exerted by appropriately combining embodiments from among the various embodiments.

While the present disclosure sufficiently describes preferred embodiments by referring to the drawings as needed, various modifications and corrections are apparent to those skilled in the art. Such modifications and corrections should be understood to be included within the scope of the present disclosure by means of the appended claims.

What is claimed is:

1. An inductor component comprising:
an element assembly configured of an insulator;
a coil conductor inside the element assembly; and
an outer electrode on an outer surface of the element assembly and electrically connected to the coil conductor, wherein
the element assembly includes a lower surface and a side surface connected to the lower surface,
the outer electrode has an L shape including a lower portion at the lower surface and a side portion at the side surface continuously with the lower portion,
the coil conductor includes a plurality of conductor patterns and a connection conductor, the plurality of conductor patterns configuring parts of an annular path on a plurality of virtual inner surfaces intersecting both the lower surface and the side surface and arranged at intervals inside the element assembly, the connection conductor electrically connecting two adjacent conductor patterns among the plurality of conductor patterns, and
when viewed in a direction orthogonal to the virtual inner surfaces, B/A obtained by dividing a distance B by a distance A is from 0.2 to 0.6, where the distance A is a shortest distance between the coil conductor and a boundary portion between the lower portion and the side portion and the distance B is a shortest distance between the coil conductor and an end portion of the lower portion opposite the boundary portion.

2. The inductor component according to claim 1, wherein
the distance A is from 57 μm to 78 μm.

3. The inductor component according to claim 1, wherein
the distance B is from 14 μm to 45 μm.

4. The inductor component according to claim 1, wherein
at least one of the plurality of conductor patterns includes an oblique edge portion extending toward the side surface in a direction parallel to the lower surface to be away from the lower surface in a direction perpendicular to the lower surface.

5. The inductor component according to claim 4, wherein
an interior angle defined by the oblique edge portion and the lower surface when viewed in the direction orthogonal to the virtual inner surfaces is from 15 degrees to 40 degrees.

6. The inductor component according to claim 4, wherein
an extended portion obtained by virtually extending the oblique edge portion intersects the side portion.

7. The inductor component according to claim 1, wherein
a dimension of the annular path in a direction perpendicular to the lower surface is from 0.6 times to 0.85 times of a dimension of the element assembly in the direction perpendicular to the lower surface.

8. The inductor component according to claim 1, wherein
at least a part of the lower portion is embedded in the element assembly, and
the coil conductor is located on an opposite side of the lower surface with respect to the part of the lower portion embedded in a direction perpendicular to the lower surface.

9. The inductor component according to claim 1, wherein
in at least one of the plurality of conductor patterns, T/W obtained by dividing a thickness T of the at least one of the conductor patterns by a width W of the at least one of the conductor patterns is 0.8 or greater.

10. The inductor component according to claim 1, wherein
a shortest distance between the two adjacent conductor patterns among the plurality of conductor patterns is 7 μm or longer.

11. The inductor component according to claim 2, wherein
the distance B is from 14 μm to 45 μm.

12. The inductor component according to claim 2, wherein
at least one of the plurality of conductor patterns includes an oblique edge portion extending toward the side surface in a direction parallel to the lower surface to be away from the lower surface in a direction perpendicular to the lower surface.

13. The inductor component according to claim 12, wherein
an interior angle defined by the oblique edge portion and the lower surface when viewed in the direction orthogonal to the virtual inner surfaces is from 15 degrees to 40 degrees.

14. The inductor component according to claim 12, wherein
an extended portion obtained by virtually extending the oblique edge portion intersects the side portion.

15. The inductor component according to claim 2, wherein
a dimension of the annular path in a direction perpendicular to the lower surface is from 0.6 times to 0.85 times of a dimension of the element assembly in the direction perpendicular to the lower surface.

16. The inductor component according to claim 2, wherein
at least a part of the lower portion is embedded in the element assembly, and
the coil conductor is located on an opposite side of the lower surface with respect to the part of the lower portion embedded in a direction perpendicular to the lower surface.

17. The inductor component according to claim 2, wherein
in at least one of the plurality of conductor patterns, T/W obtained by dividing a thickness T of the at least one of the conductor patterns by a width W of the at least one of the conductor patterns is 0.8 or greater.

18. The inductor component according to claim 2, wherein
a shortest distance between the two adjacent conductor patterns among the plurality of conductor patterns is 7 μm or longer.
